(19) United States
(12) Patent Application Publication
(10) Pub. No.: US 2014/0368860 A1
(43) Pub. Date: Dec. 18, 2014

(54) DUPLICATION-PROOF PAPER USING SPACED APART LINE SETS WITH HORIZONAL AND EXPANDED LINE PORTIONS

(71) Applicant: Jui Ching CHOU, New Taipei City (TW)

(72) Inventor: Jui Ching CHOU, New Taipei City (TW)

(21) Appl. No.: 13/919,586

(22) Filed: Jun. 17, 2013

(51) Int. Cl. H04N 1/00

(52) U.S. Cl. CPC H04N 1/0087
USPC 358/1.14

(57) ABSTRACT

A duplication-proof paper with alerting effects includes a paper proper and line sets arranged on an external surface of the paper proper. The line sets are spaced apart by a preset distance and each include an upper line and a lower line. The upper line has a preset width and comprises a horizontal line portion and an upward expanded line portion extending upward and outward from the horizontal line portion. The lower line has a preset width and comprises a horizontal line portion and a downward expanded line portion extending downward and outward from the horizontal line portion and corresponding in position to the upward expanded line portion. The horizontal line portions are spaced apart by a preset distance. The upward expanded line portion and the downward expanded line portion have an expansion zone defined therebetween and are spaced apart by a preset distance. The expansion zones form a pattern.

### BACKGROUND OF THE INVENTION

1. Technical Field

The present invention relates to duplication-proof papers, and more particularly, to a duplication-proof paper with an enhanced alerting effect,

2. Description of Related Art

In daily life, paper serves as a medium of data communication or record. For example, office workers not only often record data with paper, but also use a photocopier to produce one or more duplicates of a document for use at a meeting whenever the document has to be sent to the other colleagues or handled. For example, a student government usually records its research results with paper and produces duplicates of the written record of research results with a photocopier for the sake of publication or filing.

As mentioned above, in daily life, it is quite common for people to record data with paper and use a photocopier to photocopy a document. However, some documents are confidential documents and thus are not supposed to be photocopied readily. To this end, either access to photocopiers is placed under control, or paper is rendered. duplication-proof.

A conventional method of making a paper duplication-proof entails printing dots on the paper; wherein the dots are pale-colored, pose no hindrance to reading, and are arranged to display a warning text, such as UNAUTHORIZED DUPLICATION or DO NOT COPY As soon as, the duplication-proof paper is used in producing a duplicate of a document, the warning text is displayed on the duplicate, to thereby alert the user of the invalidity of the duplicate.

Nonetheless, using the dots to display a warning text has a drawback—the warning text displayed on a duplication-proof paper is visible before the duplication-proof paper is used in duplication, thereby encouraging dishonest users to perform unauthorized duplication with a photocopy paper which does not bear any warning text instead of one which does. As a result, the aforesaid prior art fails to ensure the alerting effect of duplication-proof papers.

Moreover, related prior art discloses a duplication-proof paper with lines printed thereon. However, a warning text intended to be hidden in the conventional duplication-proof paper is seldom completely invisible. That is to say, before duplication begins, the user sees the hidden warning text on the duplication-proof paper. The hidden warning text is visible, because not only are the lines on the duplication-proof paper bold, but line-splitting is also accompanied by a large difference between blanks. Therefore, the aforesaid prior art does not ensure the alerting effect of duplication-proof papers either.

### SUMMARY OF THE INVENTION

The present invention provides a duplication-proof paper. The duplication-proof paper comprises a paper proper and a plurality of line sets.

The paper proper comprises an external surface. The plurality of line sets is arranged and displayed on the external surface of the paper proper. The line sets are spaced apart by a first preset distance. The line sets each comprise an upper line and a lower line.

The upper line has a first preset width. The upper line comprises at least a first horizontal line portion and at least an upward expanded line portion extending upward and outward from the at least a first horizontal line portion. The lower line has a second preset width. The lower line comprises at least a second horizontal line portion and at least a downward expanded line portion extending downward and outward from the at least a second horizontal line portion. The at least a second horizontal line portion corresponds in position to the at least a first horizontal line portion. The at least a downward expanded line portion corresponds in position to the at least an upward expanded line portion.

The at least a first horizontal line portion and the at least a second horizontal line portion are spaced apart by a second preset distance. The at least an upward expanded line portion and the at least a downward expanded line portion have an expansion zone defined therebetween and are spaced apart by a third preset distance. The expansion zones of the plurality of line sets are arranged to form a pattern.

Furthermore, the first preset distance ranges from 0.01 mm to 0.6 mm. The second preset distance ranges from 0.01 mm to 0.15 mm. The third preset distance ranges from 0.01 mm to 0.45 mm. The first preset thickness ranges from 0.005 mm to 0.05 mm. The second preset thickness ranges from 0.005 mm to 0.05 mm.

Therefore, the aforesaid structural design is effective in enhancing the alerting effect of the duplication-proof paper of the present invention.

Hence, the aforesaid structural design is characterized in that: a plurality of line sets is arranged and displayed on a paper proper; the line sets each comprise an upper line and a lower line; the lines have their respective preset widths and are spaced apart by different preset distances, such that the expansion zones of the plurality of line sets are arranged to form a pattern (such as, a warning text INVALID COPY or DO NOT COPY) invisible to the users, thereby enhancing the alerting effect of the duplication-proof paper.

Furthermore, the aforesaid ranges of distance and width are the preferred results of multiple experiments conducted. Due to the aforesaid ranges of distance and width, a warning text is prevented from being displayed on the duplication-proof paper before duplication (for example, bold lines cause the warning text to be displayed before duplication), and the warning text is always displayed on the duplication-proof paper after duplication (for example, thin lines cause the warning text not to be displayed after duplication.)

The line sets are wavily arranged and displayed on the external surface, Alternatively, the line sets are obliquely arranged and displayed on the external surface.

The first preset distance equals preferably 0.31 mm. The second preset distance equals preferably 0.07 mm. The third preset distance equals preferably 0.2 mm. The first preset width equals preferably 0.01 mm. The second preset width equals preferably 0.01 mm. The first preset width and the second preset width are equal.

The pattern is a text pattern. Alternatively, the pattern is a symbol pattern. The pattern may come in the other forms, such as the logo of a company or an icon of an object.

### BRIEF DESCRIPTION OF THE SEVERAL VIEWS OF THE DRAWINGS

FIG. 1 is a plan of a duplication-proof paper before duplication according to the first preferred embodiment of the present invention;

FIG. 2 is a partial enlarged schematic view of FIG. 1;

FIG. 3 is a plan of the duplication-proof paper after duplication according to the first preferred embodiment of the present invention;

FIG. 4 is a plan of the duplication-proof paper before duplication according to the second preferred embodiment of the present invention; and

FIG. 5 is a plan of the duplication-proof paper after duplication according to the second preferred embodiment of the present invention.

### DETAILED DESCRIPTION OF THE EMBODIMENTS OF THE INVENTION

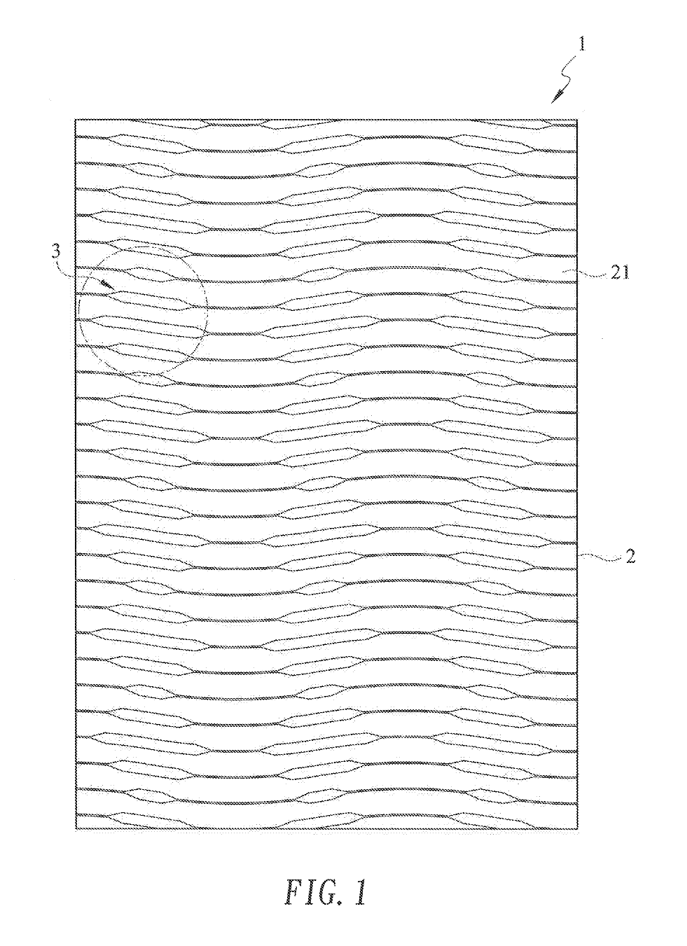

Referring to FIG. 1, there is shown a plan of a duplication-proof paper before duplication according to the first preferred embodiment of the present invention.

FIG. 1 shows a duplication-proof paper 1. The duplication-proof paper 1 comprises a paper proper 2 and a plurality of line sets 3.

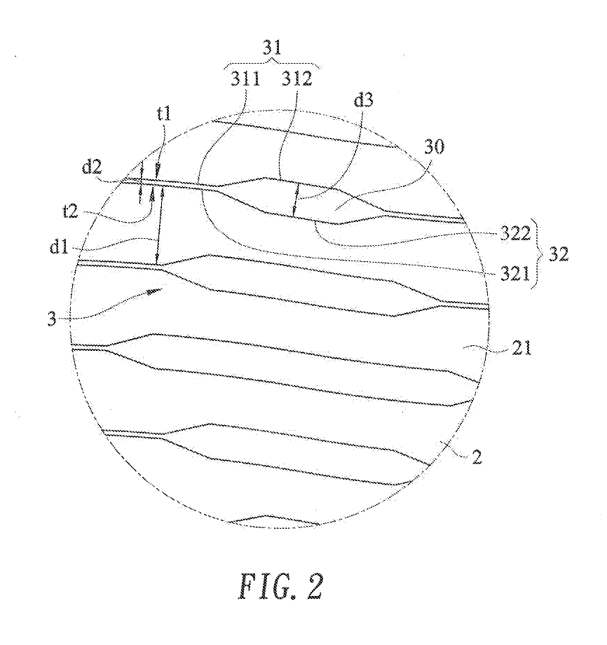

Referring to FIG. 2, there is shown a partial enlarged schematic view of FIG.

Referring to FIG. 1 and FIG. 2, the paper proper 2 comprises an external surface 21, whereas the plurality of line sets 3 is arranged and displayed (for example, printed) on the external surface 21 of the paper proper 2. For example, in this embodiment, the line sets 3 are not only wavily arranged and displayed on the external surface 21 of the paper proper 2 but also spaced apart by a first preset distance d1. The line sets 3 each comprise an upper line 31 and a lower line 32.

The Upper line 31 has a first preset width t1. The upper line 31 comprises at. least a first horizontal line portion 311 and at least an upward expanded line portion 312 extending upward and outward from the at least a first horizontal line portion 311. The lower line 32 has a second preset width t2. The lower line 32 comprises at least a second horizontal line portion 321 and. at least a downward expanded line portion 322 extending downward and outward from the at least a second horizontal line portion 321. The at least a second horizontal line portion 321 of the lower line 32 corresponds in position to the at least a first horizontal line portion 311 Of the upper line 31. The at least a downward expanded line portion 322 of the lower line 32 corresponds in position to the at least an upward expanded line portion 312 of the upper line 31.

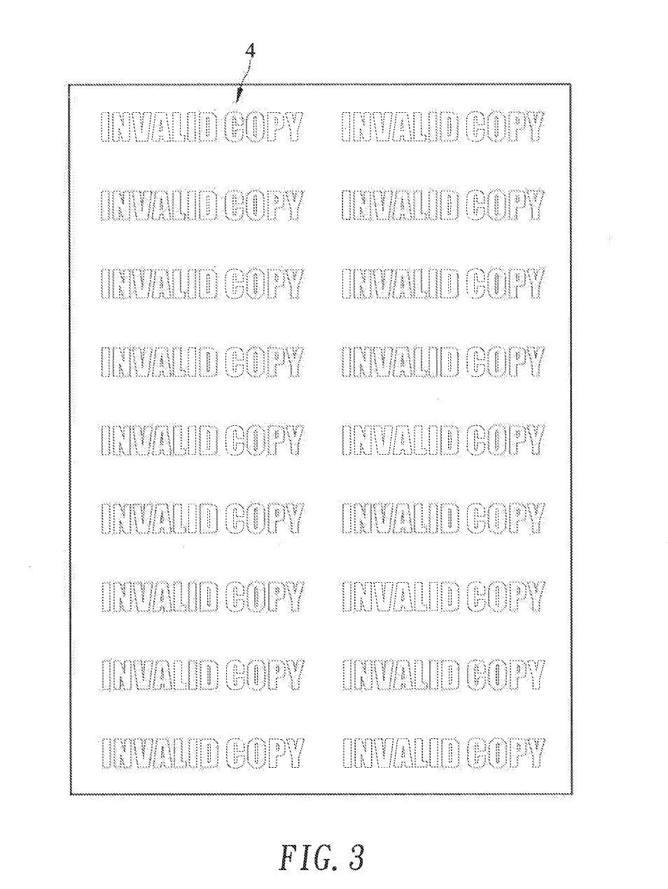

The at least a first horizontal line portion 311 of the upper line 31 and the at least a second horizontal line portion 321 of the lower line 32 are spaced apart by a second preset distance d2, The at least an upward expanded line portion 312 of the upper line 31 and the at least a downward expanded line portion 322 of the lower line 32 have an expansion zone 30 defined therebetween and are spaced apart by a third preset distance d3. The expansion zones 30 of the plurality of line sets 3 are arranged to form a pattern 4 as shown in FIG. 3.

Furthermore, the first preset distance d1 ranges from 0.01 mm to 0.6 mm. The second preset distance d2 ranges from 0.01 mm to 0.15 mm. The third preset distance d3 ranges from 0.01 mm to 0.45 mm. The first preset width t1 ranges from 0.005 mm. to 0.05 mm. The second preset width t2 ranges from 0.005 mm to 0.05 mm.

Referring to FIG. 3, there is shown a plan of the duplication-proof paper after duplication according to the first preferred embodiment of the present invention.

Referring to FIG. 1 through FIG. 3, as soon as duplication is carried out with the duplication-proof paper 1, the duplication-proof paper 1 displays the pattern 4 formed from the expansion zones 30 of the plurality of line sets 3. As shown in FIG. 3, the pattern 4 is a text pattern, such as a warning text INVALID COPY, to thereby enhance the alerting effect of the duplication-proof paper.

Specifically speaking, the aforesaid structural design is characterized in that: the plurality of line sets 3 is arranged and displayed on the paper proper 2; the line sets 3 each comprise the upper line 31 and the lower line 32; the line sets 3 are spaced apart by a first preset distance d1 (of 0.01 mm to 0.6 mm); the at least a first horizontal line portion 311 of the upper line 31 and the at least a second horizontal line portion 321 of the lower line 32 are spaced apart by a second preset distance d2 (of 0.01 mm to 0.15 mm); the at least an upward expanded line portion 312 of the upper line 31 and the at least a downward expanded line portion 322 of the lower line 32 have an expansion zone 30 defined therebetween and are spaced apart by a third preset distance d3 (of 0.01 mm to 0.45 mm); the upper line 31 has a first preset width t2 (of 0.005 mm to 0.05 mm); and the lower line 32 has a second preset width t2 (of 0.005 mm to 0.05 mm.) Hence, the expansion zones 30 of the plurality of line sets 3 are arranged to form the pattern 4 (such as a warning text INVALID COPY or DO NOT COPY). The pattern 4 is invisible before the duplication-proof paper 1 undergoes duplication, thereby enhancing the alerting effect of the duplication-proof paper.

The aforesaid ranges of distance and width are the preferred results of multiple experiments conducted. Due to the aforesaid ranges of distance and width, a warning text is prevented from being displayed on the duplication-proof paper 1 before duplication (for example, bold lines cause the warning text to be displayed before duplication), and the warning text is always displayed on the duplication-proof paper 1 after duplication (for example, thin lines cause the warning text not to be displayed after duplication.) In general, photocopying works by optical aberration. Human beings' vision has intrinsic limits; hence, the naked eye of human beings cannot perceive sufficiently thin lines and thus cannot discern any words formed therefrom. By contrast, light behaves differently from human beings' naked eye. During a scanning process performed by a photocopier, light reflected off a small gap causes the photocopier to produce a deep color, whereas light reflected off a wide gap, that is, the pattern 4 (such as a warning text INVALID COPY) formed (hidden) from the arranged expansion zones 30, causes the photocopier to produce a pale color, such that the duplication-proof paper 1 displays the reversed-out pattern 4 (warning text).

In this embodiment, the pattern 4 is a text pattern, such as the warning text INVALID COPY To allow the pattern 4 to come in different forms, it is feasible to vary the quantity of the at least a first horizontal line portion 311, the at least a second horizontal line portion 321, the at least an upward expanded line portion 312, and the at least a downward expanded line portion 322. That is to say, the quantity of the expansion. zones 30 of the plurality of line sets 3 is variable in order for the pattern 4 to come in different forms (for example, in the situation where the warning text comes in different forms).

Moreover, to further enhance the alerting effect, it is necessary for the first preset distance d1 to equal preferably 0.31 mm, for the second preset distance d2 to equal preferably 0.07 mm, for the third preset distance d3 to equal preferably 0.2 mm, for the first preset width t1 to equal preferably 0.01 mm, and for the second preset width t2 to equal preferably 0.01 mm. In this embodiment, the first preset width t1 and the second preset width t2 are equal; however, in the other embodiments, the first preset width t1 and the second preset width t2 are different in width as needed.

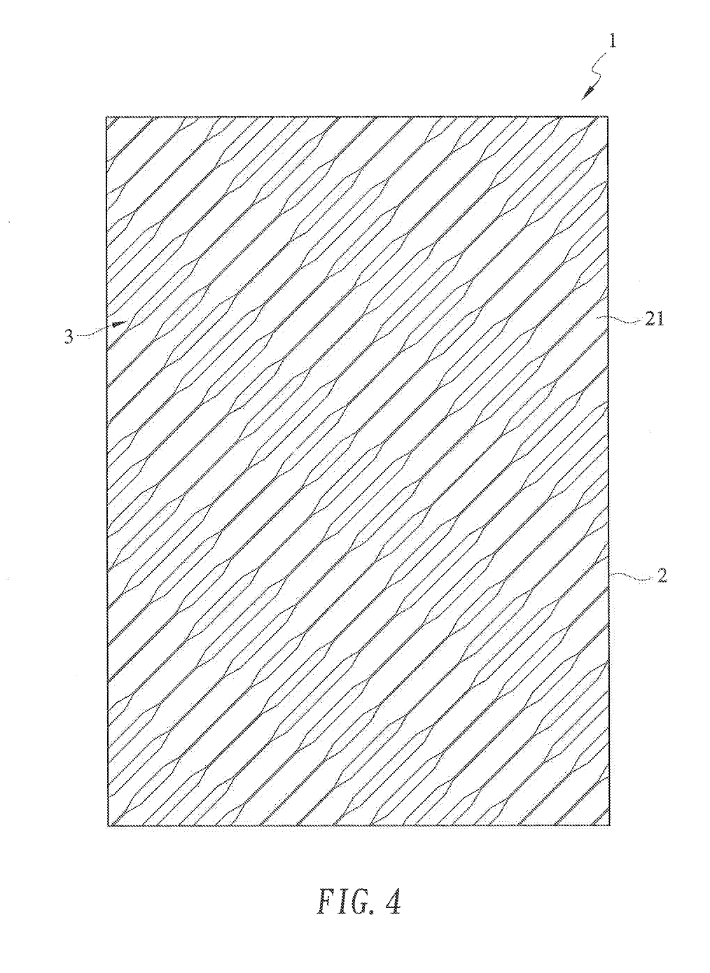

Referring to FIG. 4, there is shown a plan of the duplication-proof paper before duplication according to the second preferred embodiment of the present invention.

In this embodiment, the plurality of line sets 3 is obliquely arranged and displayed on the external surface 21 of the paper proper 2. Hence, the plurality of line sets 3 can be arranged and displayed on the external surface 21 of the paper proper 2 in different configurations. For example, in addition to the wavy arrangement in the first preferred embodiment and the oblique arrangement in the second preferred embodiment, the plurality of line sets 3 can be arranged and displayed on the external surface 21 of the paper proper 2 horizontally, vertically, or in a configuration resulting from a combination thereof.

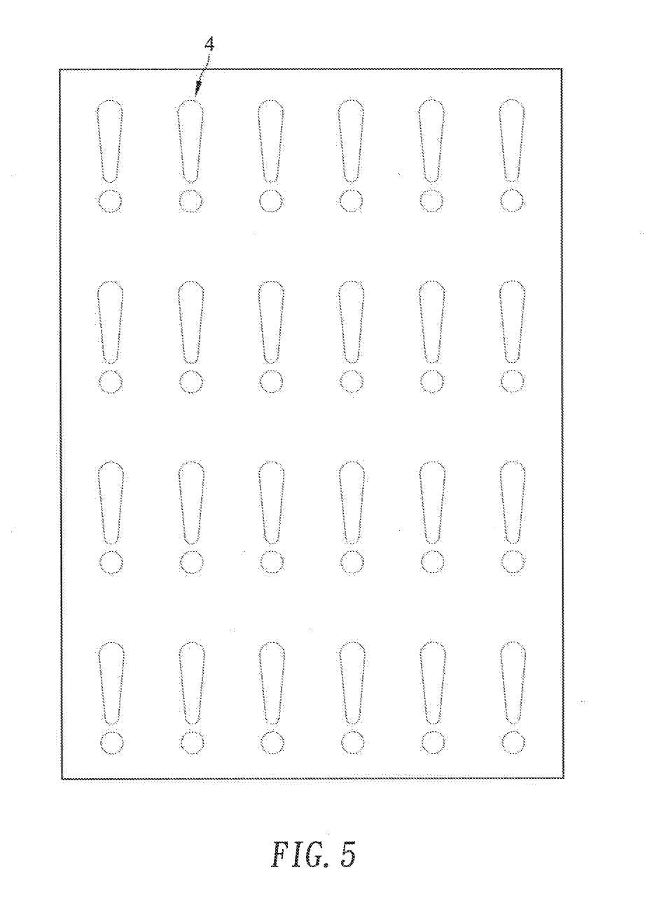

Referring to FIG. 5, there is shown a plan of the duplication-proof paper after duplication according to the second preferred embodiment of the present invention.

In this embodiment, the pattern 4 is a symbol pattern (such as an exclamation mark pattern shown in FIG. 5.) Hence, although the pattern 4 in this embodiment is a text pattern, such as a warning text, the pattern 4 is subject to changes as needed. For example, it is feasible for the pattern 4 to be the logo of a company or an icon of an object.

What is claimed is:

1. A duplication-proof paper, comprising;
a paper proper comprising an external surface; and
a plurality of line sets arranged and displayed on the external surface, the line sets being spaced apart by a first preset distance, and the line sets each comprising:
an upper line having a first preset width and comprising at least a first horizontal line portion and at least an upward expanded line portion extending upward and outward from the at least a first horizontal line portion; and
a lower line having a second preset width and comprising at least a second horizontal line portion and at least a downward expanded line portion extending downward and outward from the at least a second horizontal line portion, the at least a second horizontal line portion corresponding in position to the at least a first horizontal line portion, and the at least a downward expanded line portion corresponding in position to the at least an upward expanded line portion, wherein the at least a first horizontal line portion and the at least a second horizontal line portion are spaced apart by a second preset distance,
wherein the at least an upward expanded line portion and the at least a downward expanded line portion have an expansion zone defined therebetween and are spaced apart by a third preset distance,
wherein the expansion zones of the plurality of line sets are arranged to form a pattern, and
wherein the first preset distance ranges from 0.01 mm to 0.6 mm, the second preset distance ranges from 0.01 mm to 0.15 mm, the third preset distance ranges from 0.01 mm to 0.45 mm, the first preset width ranges from 0.005 mm to 0.05 mm, and the second preset width ranges from 0.005 mm to 0.05 mm.

2. The duplication-proof paper of claim 1, wherein the line sets are wavily arranged and displayed on the external surface.

3. The duplication-proof paper of claim 1, wherein the line sets are obliquely arranged and displayed on the external surface.

4. The duplication-proof paper of claim 1, wherein the first preset distance equals 0.31 mm.

5. The duplication-proof paper of claim 1, wherein the second preset distance equals 0.07 mm.

6. The duplication-proof paper of claim 1, wherein the third preset distance equals 0.2 mm.

7. The duplication-proof paper of claim 1, wherein the first preset width equals 0.01 mm.

8. The duplication-proof paper of claim 1, wherein the second preset width equals 0.01 mm.

9. The duplication-proof paper of claim 1, wherein the first preset width and the second preset width are equal.

10. The duplication-proof paper of claim 1, wherein the pattern a text pattern.

11. The duplication-proof paper of claim 1, wherein the pattern a symbol pattern.
